(19) United States
(12) Patent Application Publication
(10) Pub. No.: US 2006/0039048 A1
(43) Pub. Date: Feb. 23, 2006

(54) Systems and methods of capturing prints with a holographic optical element

(76) Inventors: John F. Carver, Palm City, FL (US); George W. McClurg, Jensen Beach, FL (US)

Correspondence Address: STERNE, KESSLER, GOLDSTEIN & FOX PLLC, 1100 NEW YORK AVENUE, N.W., WASHINGTON, DC, 20005, US

(21) Appl. No.: 11/209,033

(22) Filed: Aug. 23, 2005

Related U.S. Application Data
(60) Provisional application No. 60/603,282, filed on Aug. 23, 2004.

(51) Int. Cl. G03H 1/22

(52) U.S. Cl. 359/32; 359/15

(57) ABSTRACT

This invention relates to the use of holographic optical elements in the design and application of biometric scanning instruments used typically for capturing biometric information such as fingerprints and handprints. Holographic optical elements provide the opportunity for fingerprint scanning manufacturers to reduce product development cycle times, reduce product cost, size, and weight, and provide optical design flexibility not afforded by common glass and plastic optical elements. The present invention discusses various instrument embodiments employing holographic optical elements utilizing methods of holographic image reconstruction.

### CROSS-REFERENCE TO RELATED APPLICATIONS

This application claims benefit to U.S. Provisional Pat. Appl. No. 60/603,282, filed Aug. 23, 2004, the disclosure of which is hereby incorporated by reference herein in its entirety.

### BRIEF SUMMARY OF THE INVENTION

This invention relates to the use of holographic optical elements in the design and application of biometric scanning instruments used typically for capturing biometric information such as fingerprints and handprints. Holographic optical elements may be used in place of conventional fingerprint scanning elements, such as platens and prisms, to provide the opportunity for fingerprint scanning manufacturers to reduce product development cycle times, reduce product cost, size, and weight, and provide optical design flexibility not afforded by common glass and plastic refractive optical elements.

Further embodiments, features, and advantages of the present invention, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 is an illustration of a system for capturing a fingerprint image through holographic material according to an embodiment of the present invention.

FIG. 2 shows an example system for creating a structured light pattern to be projected onto an object.

FIG. 3 is an illustration of a system for capturing a fingerprint image while rejecting unwanted ambient light according to an embodiment of the present invention.

FIGS. 4A and 4B illustrate an example system for imaging a high contrast fingerprint as well as generating a calibration target.

FIG. 5 shows an example system for acquiring a rolled fingerprint from a static finger.

FIGS. 6A and 6B show an example system for capturing a fingerprint while avoiding ambient light.

The present invention will be described with reference to the accompanying drawings. The drawing in which an element first appears is typically indicated by the leftmost digit(s) in the corresponding reference number.

### DETAILED DESCRIPTION OF THE INVENTION

Holography is a method of producing an image by means of optical wave-front reconstruction. In this method, a holographic element is used to reconstruct in detail the wave field emitted by the object to be imaged. To make a holographic image, two optical beams may be used, one of which illuminates the object to be imaged. The other beam, often called a reference beam, is reflected onto an image-capturing screen or plate. Often, the output from a coherent light source (such as a laser) is separated into two beams for the illumination and reference beam purposes. Alternatively, the reference beam may be used to illuminate the object.

The image-capturing screen is exposed simultaneously to the reference beam and the reflected light from the object. The resulting interference pattern recorded by the image-capturing screen constitutes the reconstructed image, called the hologram. A hologram is a special ‘photograph’ of an object that retains information about the phase of waves coming from the actual object. The hologram is illuminated with a monochromatic optical beam (usually a laser beam). Part of the resulting diffracted wave field is a precise, three-dimensional copy of the original wave reflected by the object.

The present invention discusses the application of holographic optical elements to several instrument configurations for capturing biometric information such as fingerprints and handprints. Single or multiple reference beams are used to reproduce the print image with desired features, such as contrast, resolution, brightness etc.

While specific configurations and arrangements are discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications.

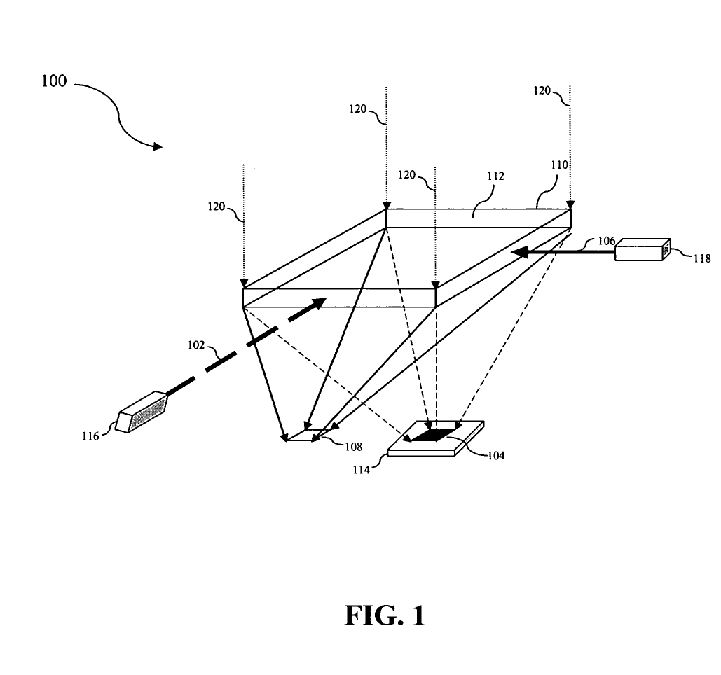

FIG. 1 is an illustration of an example system 100 for capturing a fingerprint image, as well as for imaging through holographic material 110 according to an embodiment of the present invention. Holographic material 110 may include any type of holographic material or element including, but not limited to, one or more holographic optical elements (HOEs), holographic diffraction grating(s), holographic filter(s), holographic diffractive optic(s), or combinations thereof. An example HOE may include, but is not limited to, a volume holographic optical element.

Holographic material 110 may be configured to act as one or more optical components, such as a lens and/or mirror, at various angles of input light. In this way, holographic material 110 can shape and direct incident reference beams to capture desired images including print images as described herein. When holographic material 110 is illuminated by reference beam 102, a high contrast fingerprint image 104 may be obtained. Reference beam 102 may be produced by, for example, source 116. Typically, the fingerprint image will be due to frustrated total internal reflection (“TIR”) caused by reference beam 102 at the platen surface 112 of the holographic material 110 in the presence of fingerprint ridges or valleys.

In a bright-field illumination embodiment, when a finger, for example, is placed in contact with a surface of platen 112, the TIR within platen 112 is broken by ridges of the finger. Thus, light will reflect from areas of platen 112 under valleys of the finger, while light absorbed at ridges of the finger will not be reflected. The contrast between the ridges and valleys of the finger forms an image 104 that can be viewed by a detector, such as detector 114. In this embodiment, ridges may appear relatively dark while valleys and background areas may appear relatively bright in the captured print image. Further, holographic material 110 can optionally act to focus image 104 onto detector 114. Additional optical elements or optical systems (not shown) can also be added as a further option if additional beam shaping, focusing, magnifying, or directing of image 104 onto detector 114 is desired.

Alternatively, in a dark-field illumination embodiment, incident light from holographic material 110 on platen 112 may not be directly imaged by detector 114. In a dark-field illumination embodiment, the finger is directly illuminated, and light entering the print ridges is diffused and reflected back into platen 112 in the areas where the print ridges contact platen 112 and break TIR. The light reflected from the ridges is focused at image 104, thereby producing a representative print image. The valleys and background areas may appear relatively dark while ridges may appear relatively bright in the captured print image. Like the bright-field arrangement, holographic material 110 can optionally act to focus image 104 onto detector 114 to capture image 104 in a dark-field arrangement. Additional optical elements or optical systems (not shown) can also be added as a further option if additional beam shaping, focusing, magnifying, or directing of image 104 onto detector 114 is desired.

Reference beam 106 causes the light directly above holographic material 110, such as ambient light 120, to appear at the location of image 108. For example, reference beam 106 may illuminate holographic material 110 such that holographic material 110 focuses an image 122 from incident light 120 at the location of image 108. Incident light 120 can be ambient light and/or any other type of illumination source. Image 122 may be, for example, a direct image of a face (such as in a mug shot) or other object (such as an identification card) illuminated by incident light 120. Reference beam 106 may be produced by, for example, source 118.

It is possible that the locations of image 104 and image 108 may overlap. It is also possible that the distance between the images and the holographic material may vary as designed. It is also possible that the two separate images may be generated with one reference beam. Although the two reference beams are shown perpendicular to each other, this is an illustrative example not intended to limit the present invention. A person skilled in the relevant art will recognize that alternative orientations and/or relationships between the reference beams 102, 106 and holographic material 110 may be used without departing from the spirit and scope of the present invention.

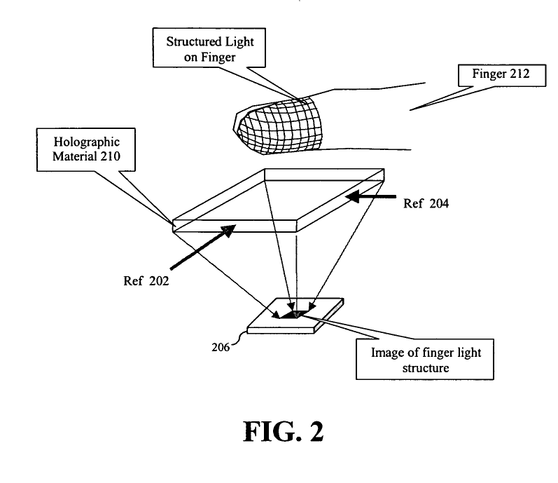

FIG. 2 shows an example system for creating a structured light pattern to be projected onto an object, such as a finger. Structured light is light having a pattern at a known angle, which can then be projected onto an object, such as finger 212. Holographic material 210 when illuminated by reference beam 204 generates structured light having, for example, a high resolution pattern. Reference beam 202 activates optics within holographic material 210 to direct the structured light toward, for example, finger 212. When the structured light intersects finger 212, it produces the pattern of light on the surface of finger 212. The pattern of light reflected from finger 212 is distorted in such a way that can indicate height variations on finger 212 being imaged by, for example, detector 206. If the pattern has a high enough resolution, detector 206 can distinguish the microstructure of finger 212 (e.g., height variations between ridges and valleys of finger 212). For instance, in one example, a super-fine grid pattern is used as the structured light. Such a super-fine grid pattern reflects differently from different locations along ridges and valleys of a print. In this way, deviations in the reflected super-fine grid pattern can be detected in a captured image and used to determine ridge and valley information of print. This information can be obtained even with a non-contacting arrangement where the finger does not have to make contact with holographic material 210. Print image data can be captured across broader contours of a finger or hand, such as the print area around a finger captured in a typical roll print or across a palm or hand in for a palm or hand print, even while the finger or hand is stationary. This makes for relatively simple capture of roll prints or large area palm or hand prints which are more difficult to detect in approaches that require contact with a flat platen surface. As a further option, other embodiments provide a non-contact arrangement where a finger, palm or hand is moved or translated across the structured light. This allows a relatively small detector scanning area to scan a relatively large print area.

There is no implied relationship between the two reference beams 202 and 204, shown in FIG. 2. Alternative orientation relationships between the two reference beams may be used. There may also be only one reference beam to implement all the desired functions, such as fingerprinting and structured light patterning. It is also possible that the distance between the image and the holographic material may vary as designed.

The imaged structured light and associated signal processing will provide a significant amount of information, such that the fingerprint image can be used for identification. The same technique may be applied to imaging other objects such as full hands and faces. One result of using this system is that it creates a high contrast fingerprint without requiring the finger to come into direct contact with a platen surface, as is required with typical optical fingerprint devices that use frustrated TIR.

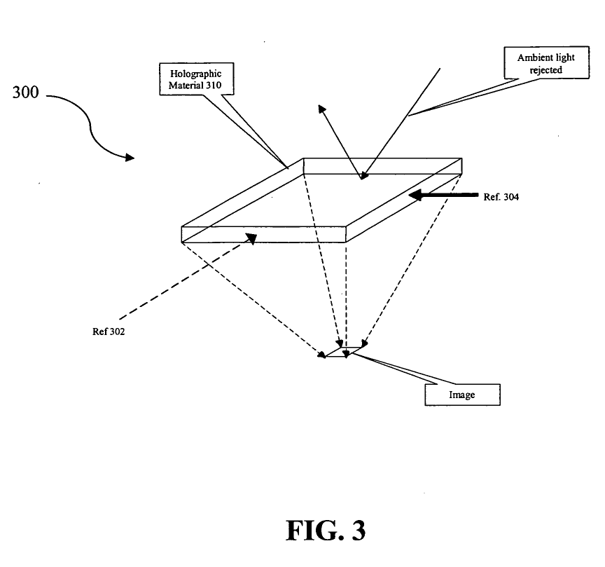

FIG. 3 is an illustration of a system 300 for capturing a fingerprint while rejecting unwanted ambient light. System 300 may be used in conjunction with system 100 described with respect to FIG. 1. In FIG. 3, reference beam 302 creates a high contrast fingerprint image. Reference beam 304 causes the surface of holographic material 310 to appear as a reflector to the unwanted ambient light. Again, a person skilled in the relevant art will recognize that alternative relationships between the orientations of the two reference beams may be used. There may also only be one reference beam to implement all the desired functions, such as fingerprinting and ambient light rejection. It is also possible that the distance between the image and holographic material 310 may vary as designed.

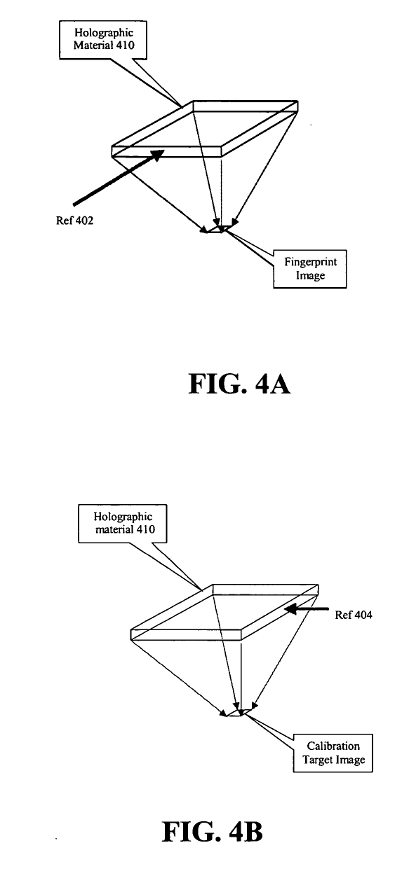

FIGS. 4A and 4B illustrate systems for imaging a high contrast fingerprint as well as generating a calibration target using holographic material 410. Alternative relationships between the orientations of the two reference beams may be used. There may also only be one reference beam to implement all the desired functions, such as fingerprint and ambient light rejection. It is also possible that the distance between the image and holographic material 410 may vary as designed.

In FIG. 4A, reference beam 402 causes holographic material 410 to generate a high contrast fingerprint image. In FIG. 4B, reference beam 402 is turned off, while reference beam 404 is turned on. When reference beam 404 is turned on, a predetermined calibration is generated by holographic material 410 which can be used to validate system operation and performance. Multiple reference beams and calibration targets can be generated to perform difference functions. Examples of desirable calibration targets include but are not limited to a bright flat illumination field, a dark flat illumination field, and a grid pattern. From these target images, information about the performance of the light source, holographic material, platen surface, and image sensor can be generated. Based on this information, steps may be taken or suggested for improving or maximizing the optical system performance.

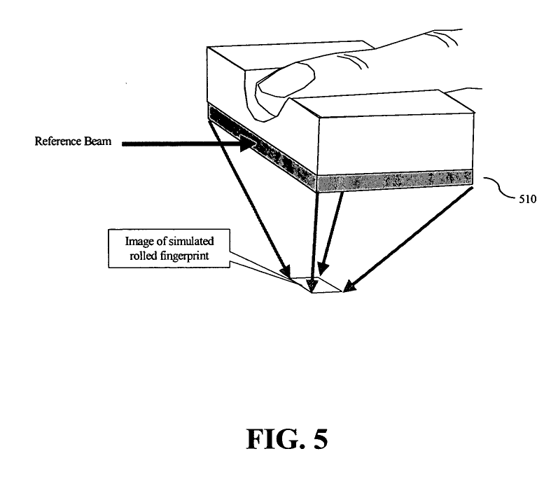

FIG. 5 shows a system for acquiring a rolled fingerprint from a static finger. The finger ridges will frustrate the light at the platen surface, thereby creating a high contrast fingerprint image. Because the finger will be placed into a curved slot, the surface area contacted by the finger is increased over that of a flat platen surface. Holographic material 510 is designed in such a way as to create a flat illumination field. It is also possible that the distance between the image and holographic material 510 may vary as designed.

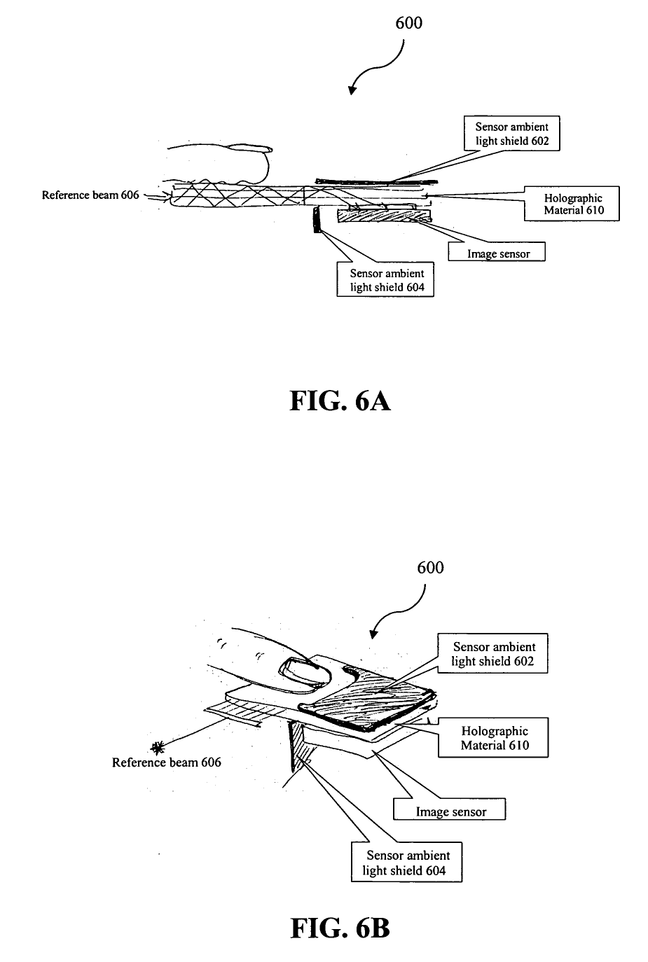

FIGS. 6A and 6B show an example system 600 for capturing a fingerprint in such a way as to position the sensor in a location that is not in line with any of the ambient light. Ambient light shields, such as light shields 602 and 604 will be in position to help block stray and undesired ambient light from reaching the image sensor. It is also possible that the distance between the image and holographic material 610 may vary as designed. Reference beam 606 can be oriented parallel to the longitudinal axis of the holographic material (as shown in FIG. 6A), or transverse to the longitudinal axis of the holographic material (as shown in FIG. 6B) on the plane of the holographic material.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method of capturing a print image using a holographic platen, comprising:
illuminating the holographic platen with a first reference beam, wherein the first reference beam causes the holographic platen to produce a high contrast image of a print pattern;
illuminating the holographic platen with a second reference beam, wherein the second reference beam causes the holographic platen to alter a path of ambient light; and
detecting the high contrast image of the print pattern.

2. The method of claim 1, wherein the second reference beam causes the holographic platen to produce an image from the ambient light.

3. The method of claim 1, wherein the first reference beam causes the holographic platen to produce the high contrast image in a first location, and the second reference beam causes the holographic platen to direct the ambient light to a second location.

4. The method of claim 3, wherein the first location and the second location overlap.

5. The method of claim 1, wherein the first reference beam causes the holographic platen to produce the high contrast image in a first location, and the second reference beam causes the holographic platen to reflect the ambient light away from the platen.

6. The method of claim 1, wherein the first reference beam causes the holographic platen to produce a structured light beam to illuminate an object having the print pattern.

7. A system for producing a holographic image of a print pattern, comprising:
a holographic platen;
a source configured to produce a first reference beam for causing the holographic platen to create a holographic image of the print pattern and a second reference beam for causing the holographic platen to alter a path of ambient light; and
an image detector configured to detect the holographic image.

8. The system of claim 7, wherein the source is further configured to produce the second reference beam for causing the holographic platen to create an image from the ambient light.

9. The system of claim 7, wherein the source is further configured to produce the first reference beam for causing the holographic platen to create the holographic image in a first location and the second reference beam for causing the holographic platen to direct the ambient light to a second location.

10. The system of claim 9, wherein the first location and the second location overlap.

11. The system of claim 7, wherein the source is further configured to produce the first reference beam for causing the holographic platen to create the holographic image in a first location and the second reference beam for causing the holographic platen to reflect the ambient light away from the platen.

12. The system of claim 7, wherein the source is further configured to produce the second reference beam for causing the holographic platen to create a structured light beam to illuminate an object having the print pattern.

13. A system for holographic imaging, comprising:
a holographic platen;
a source configured to generate a first reference beam to illuminate the holographic platen and cause the holographic platen to produce a print image; and
a detector configured to detect the print image produced by the holographic platen.

14. The system of claim 13, further comprising:
a source configured to generate a second reference beam to illuminate the holographic platen,
wherein the first reference beam causes the holographic platen to produce a holographic image of a print pattern, and the second reference beam causes the holographic platen to produce a calibration target image.

15. The system of claim 13, wherein the holographic platen has a curved platen surface and a flat illumination field.

16. The system of claim 13, further comprising:
an ambient light shield configured to prevent ambient light from reaching the detector.

17. The system of claim 16, wherein the ambient light shield is positioned in line with the detector above the holographic platen, and the reference beam illuminates the holographic platen such that the image is internally reflected longitudinally along the holographic platen to the detector.

18. The system of claim 13, wherein the first reference beam causes the holographic platen to generate a structured light beam to illuminate an object having the print pattern.

19. The system of claim 18, further comprising a source configured to generate a second reference beam for activating optical features in the holographic platen that direct the structured beam to the object having the print pattern.
